(19) United States
(12) Patent Application Publication
(10) Pub. No.: US 2026/0210188 A1
(43) Pub. Date: Jul. 23, 2026

(54) DEVICES, SYSTEMS, AND METHODS FOR A BIT HAVING AN INTEGRAL METALLIC CONNECTION

(71) Applicant: Schlumberger Technology Corporation, Sugar Land, TX (US)

(72) Inventors: Anthony GRIFFO, Houston, TX (US); Manikiran BANDI, Houston, TX (US); Jose PERALTA, Houston, TX (US)

(21) Appl. No.: 19/142,641

(22) PCT Filed: Mar. 14, 2024
(86) PCT No.: PCT/US2024/019877

§ 371 Date: Jun. 24, 2025

Related U.S. Application Data
(60) Provisional application No. 63/500,813, filed on May 8, 2023.

(51) Int. Cl. E21B 10/55; B23K 1/00; B23K 101/00

(52) U.S. Cl. CPC E21B 10/55; B23K 1/0008; B23K 2101/002

(57) ABSTRACT

A bit includes a matrix body including a matrix material that is a matrix material powder bound by an infiltrant. An integral metallic connection includes a matrix portion embedded in the matrix body and a connection portion extended from the matrix body. The connection portion and the matrix portion are integrally formed with each other. The integral metallic connection has a treated strength that is greater than or equal to 90 ksi. The integral metallic connection allows for a drill bit connection to a drill string without the usage of a joining methods (2-piece construction) typical for matrix body bit constructions.

### CROSS-REFERENCE TO RELATED APPLICATIONS

This application claims priority to U.S. provisional patent application 63/500,813 filed on May 8, 2023, the entirety of which is incorporated herein.

### BACKGROUND OF THE DISCLOSURE

Drilling is used to access subterranean formations for exploration, the extraction of natural resources (e.g., oil, natural gas, water), power generation, other uses, and combinations thereof. A downhole drilling system includes a bit that is connected to a drill string and/or other downhole tools. The bit includes a bit connection to the drill string. The bit connection is typically welded to a portion of the bit. For example, conventionally, when assembling a bit, a blank is embedded in the body of the bit. A portion of the blank extends out of the bit, and the bit connection is welded to the embedded blank within the bit.

### SUMMARY

In some aspects, the techniques described herein relate to a bit. The bit includes a matrix body including a matrix material. The matrix material includes a matrix material powder bound by an infiltrant. An integral metallic connection includes a portion embedded in the matrix body. The integral metallic connection includes a portion extended from the matrix body that is used for connecting the bit to the drill string. The integral metallic connection has a treated strength that is greater than or equal to 90 ksi. The integral metallic connection may facilitate connection with a drill string without a welded component of the integral metallic connection.

In some aspects, the techniques described herein relate to a method for manufacturing a bit. The method includes providing the bit having a matrix body and a metallic connection. The metallic connection is at least partially embedded in the matrix body. A yield strength of the metallic connection of the bit is less than 90 ksi. A new heat treatment is applied to the matrix body and the metallic connection of the bit to increase the yield strength of the metallic connection to greater than 90 ksi. During infiltration process, traditional steels used for bit connections would have heat treatment strength loss and would not be recovered. This method utilizes the infiltration and post infiltration process to promote and develop a material connection with a yield strength greater than 90 ksi.

In some aspects, the techniques described herein relate to a method for manufacturing a bit. The method includes inserting an integral metallic connection into a bit mold. The integral metallic connection includes a matrix portion integrally formed with a connection portion. The method includes flowing matrix material and an infiltrant into the bit mold around the integral metallic connection. The matrix material includes a matrix material powder. The method includes heating the integral metallic connection, the matrix material, and the infiltrant to an infiltration temperature to form an infiltrated matrix body with the integral metallic connection embedded in the infiltrated matrix body. The method includes cooling the infiltrated matrix body and the integral metallic connection to a room temperature. The method includes de-molding the infiltrated matrix body and the integral metallic connection from the bit mold, and heating the infiltrated matrix body and the integral metallic connection to a brazing pre-heat temperature.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 shows one example of a drilling system for drilling an earth formation to form a wellbore; according to at least one embodiment of the present disclosure;

FIG. 2 is a representation of a bit having an integral metallic connection, according to at least one embodiment of the present disclosure;

FIG. 3-1 through FIG. 3-3 are representations of the formation of a bit including an integral metallic connection embedded in a matrix body, according to at least one embodiment of the present disclosure;

FIG. 4-1 through FIG. 4-4 are representations of thermal cycles experienced by an integral metallic connection during formation of a bit, according to at least one embodiment of the present disclosure;

FIG. 5 is a flowchart of a method for manufacturing a bit, according to at least one embodiment of the present disclosure; and

FIG. 6 is a flowchart of a method for manufacturing a bit, according to at least one embodiment of the present disclosure.

### DETAILED DESCRIPTION

This disclosure generally relates to devices, systems, and methods for a bit having a metallic connection inserted into a matrix body. The metallic connection may include a portion that is embedded in the matrix and a portion that extends out of the matrix. The matrix portion that is embedded in the matrix may be integrally formed with a connection portion that extends out of the matrix. The connection portion may be processed, after the bit is cast, to form a connection with another portion of a drilling system.

During formation of the bit, the integral metallic connection may be subjected to a thermal cycle that results in a microstructure that provide mechanical properties sufficient for drill string connections. In accordance with at least one embodiment of the present disclosure, during formation of the bit, the integral metallic connection may be subjected to a thermal cycle that results in a strength that meets standards set by the American Petroleum Institute (API) for materials used in downhole environments. For example, the integral metallic connection may be subjected to a thermal cycle that results in a strength that meets and/or exceeds the API standards for connections between two portions of a drill string, or for connections between the bit and the drill string. In some examples, the resulting treated strength may meet and/or exceed the API standard for threaded connections. In some embodiments, the microstructure of the integral metallic connection, and the resulting strength of the integral metallic connection, is achieved without conventional processes and/or heat treatments that are associated with conventional metallic components used for a two-piece bit connection. For example, conventional metallic connections include metallic groups, such as AISI4140, that utilize water quenching from austenite zone (>1650° F.). This water quenching may be detrimental to bit body construction. Thus, the conventional bit uses a joining operation, such as submerged arc welding, to join a partially embedded blank of a different material (e.g., AISI1020) with a conventional metallic connection material (e.g., AISI4140) to allow for high strength connections between these two elements. The conventional partially embedded blank may not have sufficient strength to satisfy the API standard for threaded connections without the joining operation.

In accordance with at least one embodiment of the present disclosure, during formation of the bit, the integral metallic connection may have any pre-existing heat treatment removed during infiltration of the matrix body when the integral metallic connection is inserted into the matrix body. For example, the integral metallic connection may be raised above a threshold temperature for the metallic alloy (such as the solutionizing temperature for the metallic alloy), where phases present have been altered thereby removing or reducing the pre-existing heat treatment for the metallic alloy. For example, the phase changes in a traditional embedded metallic blank, typically an AISI1020 steel material, transform from ferrite/cementite structure to austenite during infiltration. This phase will then transform again upon completion of the infiltration cycle. However, conventional cooling and brazing processes applied to a conventional metallic blank of AISI1020 produce low mechanical strength, which are not sufficient for drill string connections. That is, the temperature of infiltration (>1900F) would transform most traditional metallic materials, such as AISI1020 steel, during infiltration to essentially remove their previous heat treatment. The metallic connection (e.g., integral metallic connection) described herein may then undergo a new heat treatment, such as precipitate hardening. For example, when the matrix body is pre-heated prior to brazing, the integral metallic connection may be heated as well. This pre-heating may cause the metallic alloy in the integral metallic connection to undergo precipitate hardening. In this manner, formation of the bit may remove any pre-existing heat treatment from the integral metallic connection, and apply a new heat treatment. Precipitation hardening is one embodiment of this disclosure, although other forms of processing and/or heat treatment are considered herein.

In accordance with at least one embodiment of the present disclosure, to form a bit having an integral metallic connection, the integral metallic connection may be inserted into a bit mold. The bit mold may be filled with a matrix material, such as a powdered metallic and/or refractory material. The bit mold and the integral metallic bit may be heated to an infiltration temperature, at which temperature an infiltrant may melt and infiltrate the powdered matrix material to bind the matrix material into a matrix body. The infiltration temperature may meet or exceed a solutionizing temperature of the integral metallic connection. When the infiltration process is complete, the infiltrated matrix body and the integral metallic connection may be cooled to a room temperature. The cooling process may include slow-cooling, air-cooling, cooling without quenching, and combinations thereof. Prior to brazing cutting elements on the bit, the infiltrated matrix body and the integral metallic connection may be heated to a brazing pre-heat temperature. The brazing pre-heat temperature may be associated with a precipitation hardening temperature of the integral metallic connection. In this manner, cooling the integral metallic connection from the infiltration temperature, and then heating to the brazing pre-heat temperature may cause the integral metallic connection to form a precipitate hardened microstructure.

In some embodiments, the integral metallic connection may be cooled in another manner, including a quenching processes, such as directional quenching with a water-based and/or an oil-based fluid. For example, the integral metallic connection may be rapid cooled, such as through directed water and/or oil jets into the integral metallic connection or at a bit mold around the bit. This may help to promote the formation of martensite and/or bainite over ferritic and/or pearlite in the steel of the integral metallic connection. In some embodiments, after cooling, the integral metallic connection may undergo further thermal cycles to temper the integral metallic connection.

As illustrated by the foregoing discussion, the present disclosure utilizes a variety of terms to describe features and advantages of the bit including the integral metallic connection. Additional detail is now provided regarding the meaning of such terms. For example, the term “heat treatment” may refer to the process of adjusting the temperature of a metallic alloy to change the microstructural properties of the metallic alloy. In some embodiments, heat treatment may refer to the process of increasing the strength and/or hardness of a metallic alloy through controlled changes in the microstructure brought about by changes in temperature.

In some embodiments, as used herein, the term thermal cycle refers to the changes in temperature an object is subjected to over time. In particular, the term “thermal cycle” may refer to the increase in temperature to one or more soak (e.g., holding) temperatures, the rate of increase in temperature, the amount of time spent at the soak temperatures, the lowering in temperature to a different soak temperature, the rate of decrease in temperature, any other changes in temperature, and combinations thereof. In some embodiments, a thermal cycle may include a single increase and decrease in temperature. In some embodiments, a thermal cycle may include multiple increases and decreases in temperature. In some embodiments, a thermal cycle may include a single holding temperature. In some embodiments, a thermal cycle may include multiple soak temperatures and/or soaking times.

As used herein, the term “solutionizing temperature” may refer to the temperature, above which, a metallic alloy may form a microstructurally homogeneous solid solution. In some embodiments, the solutionizing temperature may be a solvus temperature (e.g., the temperature that separates a solid phase between two microstructures) for a particular metallic alloy. Heating a metallic alloy above the solutionizing temperature may dissolve any precipitates/phases of the first solid phase in the solid solution, resulting in the homogeneous solution of the second solid phase. This may result in a softening of the metallic alloy, or a reduction in the strength and/or hardness of the metallic alloy.

As used herein, the term “precipitate hardening temperature” may refer to the temperature, above which, portions of a metallic alloy may experience a change in microstructure. For example, above the precipitate hardening temperature, one or more structures may precipitate in the solid metallic alloy solution. These precipitates may result in an increase in the hardness and/or strength, changes in ductility, changes in toughness, any other property changes, and combinations thereof of the metallic alloy.

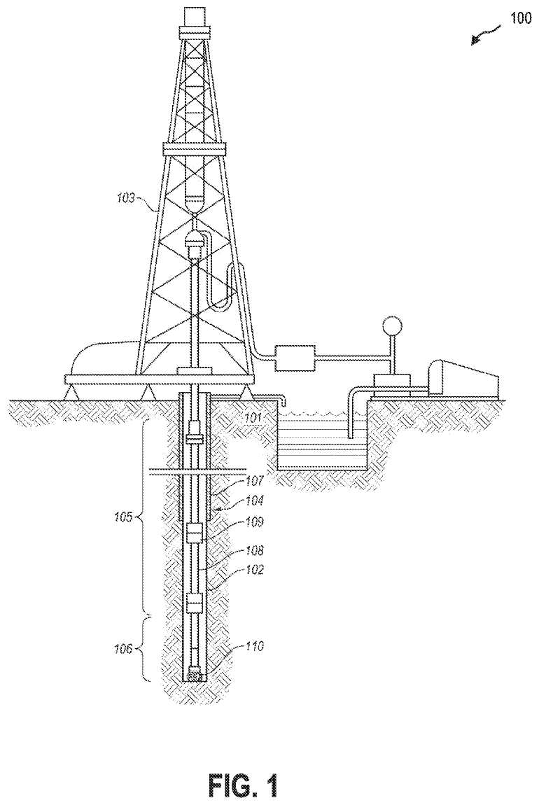

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The tool joints 109 may include any connection between two elements of the drill string 105 and/or the BHA 106, including connections between the bit 110 and the next uphole tool and/or element of the BHA 106. As discussed herein, the API may have standards for the connection strength of the tool joints 109. Each of the tool joints 109 in the drill string 105 and/or other portions of the drilling system 100 may be compliant with the API standards.

The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

In accordance with at least one embodiment of the present disclosure, the bit 110 may include a connection to the RSS and/or other portion of the BHA 106. Conventionally, during manufacturing of a bit 110, a steel blank may be inserted into a bit mold and a matrix body may be formed around the steel blank. The steel blank may extend out of the bit body. To connect the bit to the RSS and/or other portion of the BHA 106, the steel blank may be secured to a bit connection. Conventionally, the steel blank may be welded to the bit connection. Welding the steel blank to the connection portion may increase the manufacturing time, expense, and/or complexity of the bit 110. In some situations, welding the steel blank to the connection portion may extend the length of the bit 110. For example, welding the connection portion to the steel blank may include machining grooves or other welding section into the outer periphery of the steel blank and the connection portion. The grooves may be filled in using welding material, and the grooves may increase the contact length of the weld, thereby increasing the strength of the welded connection.

The distance between the uppermost cutter of the bit 110 and the RSS may help to determine the dog leg severity (DLS) of the RSS. For example, a shorter distance between the bit 110 and the RSS may increase the DLS of the RSS. As discussed above, the welded connection between the steel blank and the connection portion may increase the length of the bit, thereby reducing the maximum possible DLS of the RSS.

In accordance with at least one embodiment of the present disclosure, the bit 110 may be formed using a metallic connection. The metallic connection may include a matrix portion that is embedded in the matrix body of the bit 110 and a connection portion that may extend out of the matrix body. In some embodiments, the matrix portion may be integrally formed with the connection portion, thereby forming an integral metallic connection. Having a steel blank with an integrally formed matrix portion and connection portion may help to reduce the amount of processing used to prepare the bit 110, thereby reducing the cost and/or time used to prepare the bit 110.

In some embodiments, utilizing an integral metallic connection having a matrix portion and a connection portion may help to reduce the length of the bit. For example, forming the bit 110 with the integral metallic connection may help to reduce the length that the weld and/or the connection between the matrix portion and the connection portion may otherwise utilize. This may help to reduce the length of the bit, which may help to increase the DLS of the RSS.

In accordance with at least one embodiment of the present disclosure, the integral metallic connection may be subjected to a thermal cycle during manufacturing of the bit. The thermal cycle may cause the integral metallic connection to undergo a heat treatment. For example, the thermal cycle undergone by the integral metallic connection may result in a treated yield strength of 90 ksi (620 MPa), 100 ksi (690 MPa), 110 ksi (758 MPa) or greater. This may meet or exceed the API specifications for drill string connections, such as connections between the drill bit and a drill pipe or drill collar.

In some embodiments, the thermal cycle is a result of the infiltration and pre-heating for brazing of the matrix body of the bit 110. For example, during manufacturing of the bit, the matrix powder, infiltrant, and integral metallic connection may be heated to the infiltration temperature. The infiltration temperature may meet or exceed the solutionizing temperature of the integral metallic connection. In some embodiments, the infiltrated matrix body and integral metallic connection are cooled to room temperature to de-mold the matrix and/or perform initial processing of the matrix body, such as cleaning up the matrix body, cleaning out the cutting element pockets, other processing of the matrix body, and combinations thereof.

In some embodiments, the infiltrated matrix body and integral metallic connection are then pre-heated to a brazing pre-heat temperature prior to brazing the cutting elements into the cutting element pockets. The brazing pre-heat temperature may be associated with a precipitate hardening temperature of the integral metallic connection. When the infiltrated matrix body and integral metallic connection are pre-heated to the brazing pre-heat temperature, the integral metallic connection may undergo precipitate hardening. This brazing pre-heat process may cause the hardness and/or strength of the integral metallic connection to increase. In some embodiments, the integral metallic connection has a hardened strength of 90 ksi, 100 ksi, 110 ksi, or greater. Moreover, the strength of the integral metallic connection may be increased after the infiltration process without a separate step. That is, the brazing pre-heat process may simultaneously increase the strength of the integral metallic connection to 90 ksi or greater, and reduce thermal shock or thermal stresses on the bit during the brazing process.

In some embodiments, the connection portion of the integral metallic connection is machined or processed to form a connection to the RSS and/or the BHA 106. In this manner, the bit 110 may have a connection that is integrally formed with the matrix body of the bit 110. The strength of the connection portion of the integral metallic connection may meet or exceed the API standards for connections. This may help to reduce the cost, time, and/or complexity of forming the bit 110 and/or help to reduce the length of the bit 110.

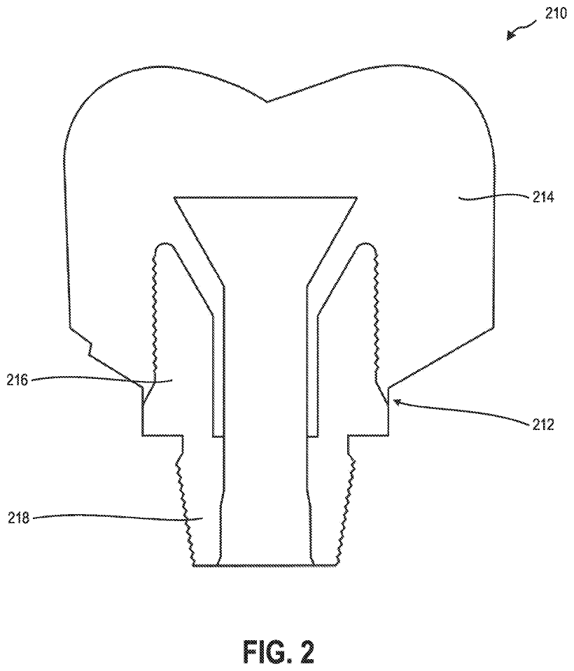

FIG. 2 is a representation of a bit 210 having a metallic connection 212, according to at least one embodiment of the present disclosure. The bit 210 may include a matrix body 214. The matrix body 214 may be formed from a matrix powder that is infiltrated with a metallic binder (i.e., infiltrant). The matrix powder may be any type of matrix powder, such as a metallic matrix powder, a ceramic matrix powder, a carbide matrix powder, a refractory material matrix powder, any other matrix powder, and combinations thereof. The infiltrant may be any type of infiltrant, including a copper-based infiltrant, a nickel-based infiltrant, a cobalt-based infiltrant, any other infiltrant, and combinations thereof.

The metallic connection 212 may be formed from any metallic material. For example, the metallic connection 212 may be formed from a ferrous steel or steel alloy. In some examples, the metallic connection 212 may be formed from a cobalt-based alloy. In some examples, the metallic connection 212 may be formed from a nickel-based alloy. In some examples, the metallic connection 212 may be formed from a ferrous-based alloy, including stainless alloys, martensitic grades (17-4PH, 13-8Mo), austenitic grades (17-7PH AM350, 15-7PH), high strength low alloy steels (medium carbon grades including 4140, 8630, 4145), and combinations thereof. In some examples, the metallic connection 212 may be formed from a nickel alloy, including UNS N06625, UNS N07718, UNS N08810. The list provided are for exemplary demonstration and not exhaustive.

In some embodiments, the metal alloy of the metallic connection 212, the particular infiltrant, and the material used for the matrix material may be selected to coordinate and/or synergize. For example, the materials may be selected to have complementary coefficients of thermal expansion. This may help to prevent cracking and/or other issues caused by a mismatch of the coefficient of thermal expansion. In some embodiments, a particular binder may be matched to a particular metal alloy for the metallic connection 212. This may help to improve the bond between the infiltrated matrix body and the matrix embedded portion of the metallic connection 212.

The metallic connection 212 may have a matrix portion 216 and a connection portion 218. The matrix portion 216 may be embedded in and/or inserted into the matrix body 214 of the bit 210. The connection portion 218 may extend out of the matrix body 214. In accordance with at least one embodiment of the present disclosure, the matrix portion 216 and the connection portion 218 are integrally formed. For example, the matrix portion 216 and/or the connection portion 218 may be formed from the same bar of metal without weld, joint, connection, or other interface between the matrix portion 216 and the connection portion 218. As discussed herein, this may help the bit 210 to be formed without welding a separate connection to an embedded blank of steel or other metallic material, thereby reducing the cost, time, complexity, and combinations thereof of manufacturing the bit. In some embodiments, integrally forming the matrix portion 216 and the connection portion 218 may help to reduce the length of the integral metallic connection 212, thereby reducing the overall length of the bit 210. In some embodiments, the matrix portion 216 and the connection portion 218 are joined together prior to embedding the matrix portion 216 in the matrix body 214. For example, the matrix portion 216 and the connection portion 218 may be welded, fused, interlocked, threaded together, fastened, press-fit, shrink-fit, or otherwise connected prior to arrangement as the metallic connection 212 in the matrix body 214. In some embodiments, the matrix portion 216 and the connection portion 218 may be formed of different materials, such as different steel alloys. As discussed herein, the metallic connection 212 formed by any process may undergo a heat treatment process after arrangement within the matrix body 214, and the heat treatment process alters the strength of the metallic connection 212 to a treated strength that meets or exceeds API standards for connection of the bit 210 with a component of the drill string. For example, the metallic connection 212 formed by any process may undergo a heat treatment process after arrangement within the matrix body 214, and the heat treatment process alters the strength of the metallic connection 212 to a treated strength of 90 ksi or greater, thereby facilitating connection of the bit 210 with a component of the drill string. The metallic connection 212 of the bit 210 may have the desired treated strength without a post-infiltration welding process.

As may be seen, the matrix portion 216 may be at least partially embedded in the matrix body 214. During manufacturing, the matrix portion 216 of the integral metallic connection 212 may be inserted into the bit mold. To form the infiltrated matrix body bound by the infiltrant, the matrix material powder may be flowed into the bit mold around the matrix portion 216. The connection portion 218 may extend out of the bit mold and/or the matrix material powder may be filled around the matrix portion 216 along the length of the body of the bit. The bit 210, including the matrix material powder, the infiltrant, and the integral metallic connection 212 may be heated to the infiltration temperature, thereby allowing the infiltrant to melt and infiltrate the matrix material powder, thereby forming the matrix body 214. In this manner, the matrix body may include a matrix material powder bound by the infiltrant.

In the embodiment shown, the integral metallic connection 212 does not include a breaker slot. Conventionally, the breaker slot may be formed at the welded connection between the embedded steel blank and the connection based on the room allowed by the welded connection. Alternatively, conventional bits may have breaker slot machined solely in the connection portion only, making the overall bit longer. In some embodiments, the integral metallic connection 212 may include a breaker portion. In some embodiments, the bit 210 may include a breaker (e.g., octagonal breaker) in a gage region of the bit. An octagonal breaker in the gage region may occupy less length than a conventional two-sided breaker between the matrix portion 216 and the connection portion 218.

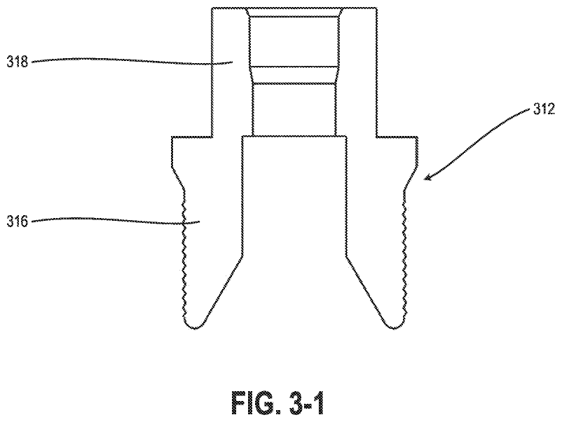

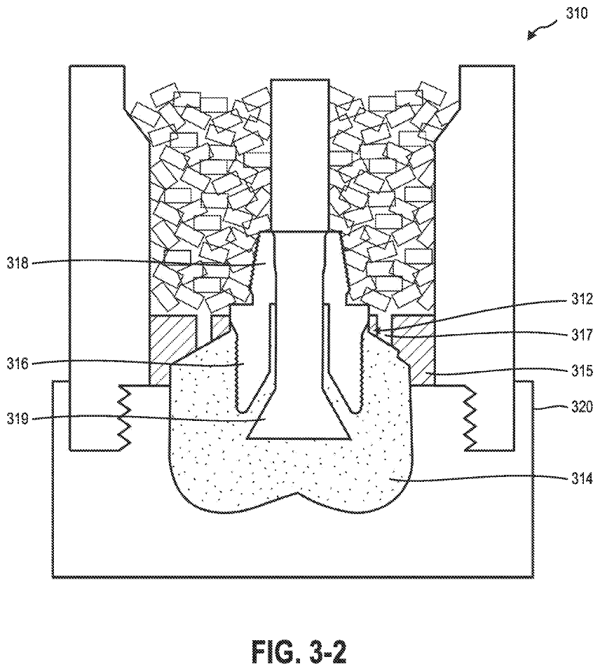

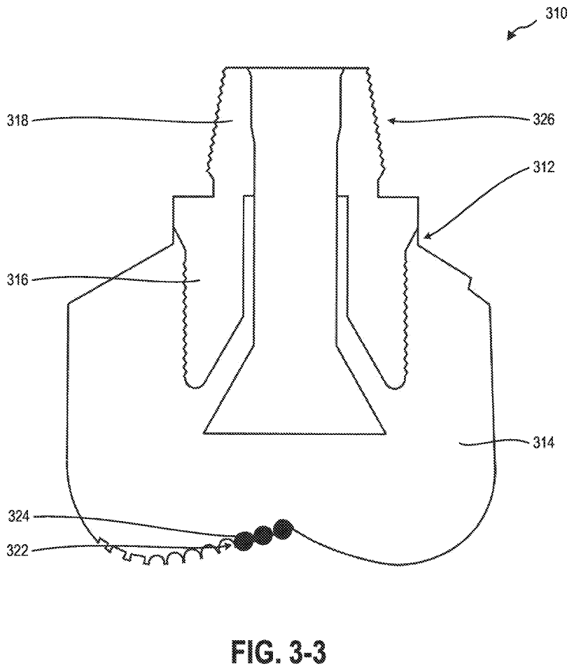

FIG. 3-1 through FIG. 3-3 are schematic representations of the manufacturing of a bit 310, according to at least one embodiment of the present disclosure. FIG. 3-1 illustrates an integral metallic connection 312 having a matrix portion 316 integrally formed with a connection portion 318. As discussed herein, the integral metallic connection 312 may be formed from a metallic alloy.

In some embodiments, the matrix portion 316 includes one or more retention features that, when embedded in the matrix, may secure the matrix head to the integral metallic connection 312. The retention features may include one or more grooves, detents, protrusions, patterns, any other retention feature, and combinations thereof. The retention features may secure the matrix portion 316 to the matrix such that the matrix portion 316 may not be removed without plastically deforming and/or fracturing the matrix portion 316 and/or the matrix of the bit body. In some embodiments, the connection portion 318 does not include any connection elements. For example, the connection portion 318 may not include any threads, bolt holes, other connection elements, and combinations thereof. As discussed herein, the connection portion 318 may be processed after the bit 310 is formed to form connection elements. The connection portion 318 may form a pin connection or a box connection to join the bit 310 with a drill string or tool of the BHA.

In FIG. 3-2, the integral metallic connection 312 has been inserted into a bit mold 320. The bit mold 320 may include an inverted representation or approximate representation of the matrix body 314. The integral metallic connection 312 may be inserted into the inverted representation of the matrix body 314. To form an infiltrated matrix body bound by the infiltrant, the matrix material powder may be poured into the inverted representation of the matrix body 314 and/or flowed around the integral metallic connection 312. While forming the bit, the shape of the matrix body 314 may be maintained by a casting element 315, with pathways 317 through the casting element 315 for infiltrant to flow into the matrix material powder. A crow's foot 319 may be inserted into the matrix material powder of the matrix body 314 (and through the integral metallic connection 312) to form a plenum in the bit to distribute drilling fluid to various nozzles and orifices in the bit. As may be seen, the connection portion 318 of the integral metallic connection 312 extends longitudinally past the inverted representation of the matrix body 314. In some embodiments, the connection portion 318 extends out of the bit mold 320.

In some embodiments, to form the bit 310, an infiltrant may be placed on top of the matrix material powder in the inverted representation of the matrix body 314. The bit mold 320, matrix material powder, infiltrant, and integral metallic connection 312 may be heated to the infiltration temperature. This will cause the infiltrant to melt and infiltrate the spaces between the matrix material powder and around the matrix portion 316 of the integral metallic connection 312. This may result in an infiltrated matrix material powder bound by an infiltrant.

As infiltrated matrix body 314 cools, the infiltrant may solidify. This may cause the matrix body 314 to be secured to the matrix portion 316 of the integral metallic connection 312. After the infiltrated matrix body 314 and the integral metallic connection 312 are cooled, the bit 310 may be de-molded. For example, the matrix body 314 and the connected integral metallic connection 312 may be removed from the bit mold 320.

In some embodiments, the bit 310 is processed after the bit 310 is de-molded. For example, the matrix body 314 may be cleaned, including removing excess material from the matrix body 314, cleaning out one or more cutting element pockets 322, otherwise processing the matrix body 314, and combinations thereof.

The bit 310 may have one or more cutting elements 324 secured to the bit 310 at the cutting element pockets 322. The cutting elements 324 may be brazed to the cutting element pockets 322. The brazing process may include inserting a cutting element 324 into the cutting element pocket 322 with a brazing material. The cutting element 324, the material surrounding the cutting element pocket 322, and the brazing material may be heated to a brazing temperature. At the brazing temperature, the brazing material may melt and flow into the space between the cutting element 324 and the cutting element pocket 322. When the brazing material solidifies, the brazing material may secure the cutting element 324 to the cutting element pocket 322.

To reduce the thermal stress applied to the matrix body 314 during the brazing process, the bit 310, including the matrix body 314 and the integral metallic connection 312 may be pre-heated to a brazing pre-heat temperature. This may cause the integral metallic connection 312 to undergo precipitate hardening or another heat-treatment process, which may increase the hardness and/or strength of the integral metallic connection 312, including the connection portion 318 extending out of the matrix body 314. The pre-heating may be considered for both the integral metallic connection and the bit as these temperatures may affect mechanical properties based on the metallic system employed.

In some embodiments, during the brazing process, the integral metallic connection 312 may not be thermally protected from brazing heat. For example, the integral metallic connection 312 may not have any thermal shield, insulation, cooling, or other form of thermal protection to prevent or reduce temperature increase at the integral metallic connection 312.

When the bit 310 cools after brazing the cutting elements 324 to the cutting element pockets 322, the connection portion 318 may be processed to form the connection element. For example, in the embodiment shown in FIG. 3-3, the connection portion 318 may be machined to form a threaded connection 326. In some embodiments, the connection portion 318 may have a connection strength of greater than or equal to 90 ksi. In some embodiments, the connection portion 318 may have a connection strength of greater than or equal to 100 ksi. In some embodiments, the connection portion 318 may have a connection strength of greater than or equal to 110 ksi. In some embodiments, the connection portion 318 is processed after the bit 310 cools after brazing. In this manner, the connection portion 318 may be processed after the connection portion 318 undergoes precipitate hardening. This may help to prevent deformation of the connection portion 318 during formation of the bit, such as during the infiltration.

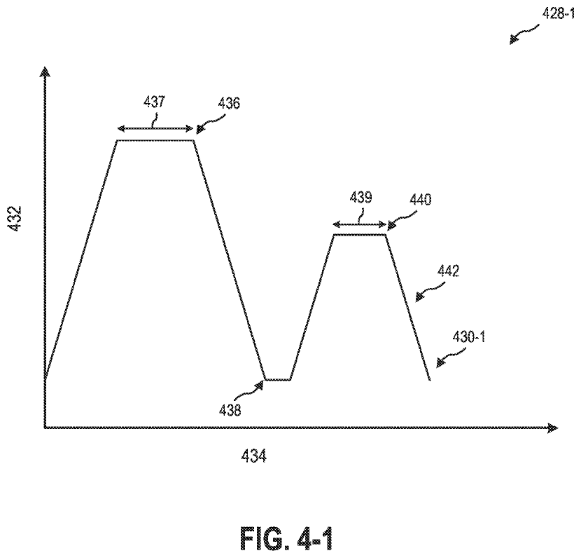

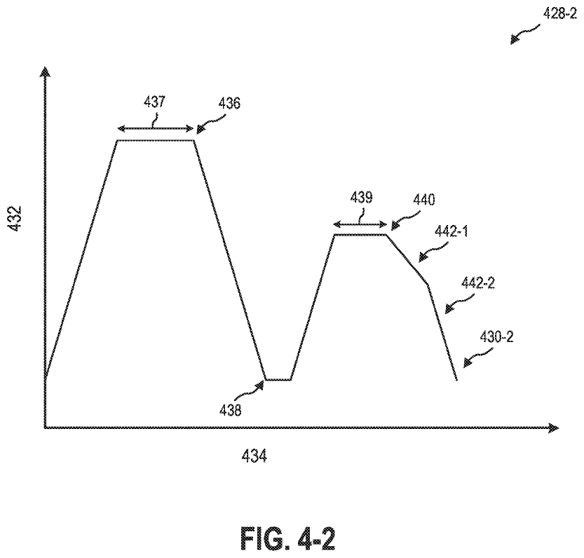

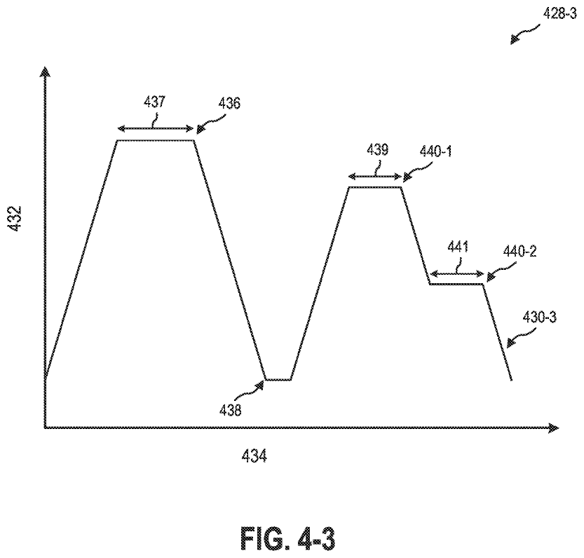

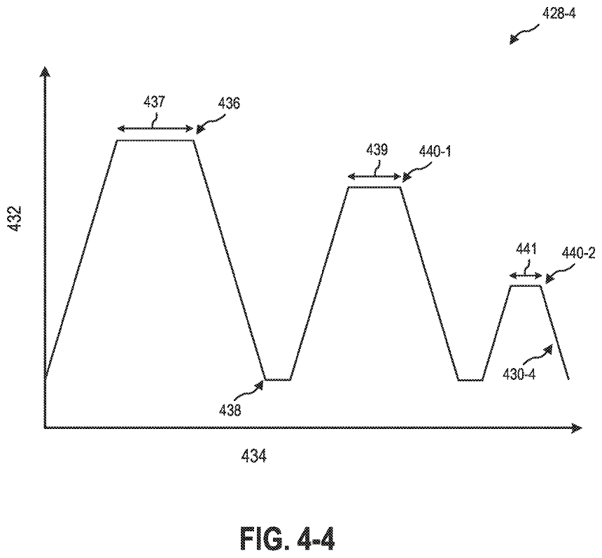

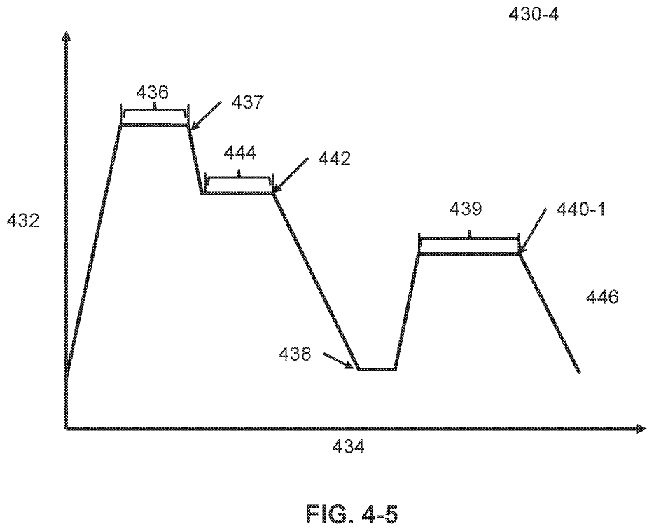

FIG. 4-1 is a representation of a first thermal cycle chart 428-1 illustrating a first thermal cycle 430-1 that a bit (e.g., the bit 210 of FIG. 2) and the associated integral metallic connection (e.g., the integral metallic connection 212 of FIG. 2) may experience while manufacturing the bit. In some embodiments, the cycle may be a three-step furnace cycle. The three-step furnace cycle can include (1) a preheat portion that can help to drive out moisture and reduce shock, (2) a hot box wherein infiltration occurs, and (3) a cooling cycle. In various embodiments, the preheat portion can be less than 600 F and the hot box portion can be between 1900 and 2300 F. The first thermal cycle chart 428-1 shown illustrates temperature 432 on the vertical axis (e.g., the y-axis) and time 434 on the horizontal axis (e.g., the x-axis).

As may be seen on the first thermal cycle 430-1, the bit may be heated to a first holding temperature 436. The first holding temperature 436 may correspond to the infiltration temperature of the infiltrant used to bind the matrix material powder, resulting in an infiltrated matrix body. The bit and the integral metallic connection may be held at the first holding temperature 436 for a first holding period 437. In some embodiments, the holding period 437 may be the amount of time the bit may be held at the first holding temperature 436 for the infiltrant to melt and infiltrate the matrix material powder to form the infiltrated matrix body bound by the infiltrant.

In some embodiments, the first holding temperature 436 meets or exceeds the solutionizing temperature of the integral metallic connection. In some embodiments, the first holding temperature 436 is equal to or greater than the solutionizing temperature of the integral metallic connection. In some embodiments, the first holding temperature 436 is less than the melting temperature of the integral metallic connection. In some embodiments, the first holding period 437 may meet or exceed the period to solutionize the integral metallic connection.

In some embodiments, the first holding temperature 436 may be in a range having an upper value, a lower value, or upper and lower values including any of 1,850° F. (1,010° C.), 1,900° F. (1,038° C.), 2,000° F. (1,093° C.), 2,100° F. (1,149° C.), 2,200° F. (1,204° C.), 2,300° F. (1,204° C.), 2,400° F. (1,316° C.), or any value therebetween. For example, the first holding temperature 436 may be greater than 1,850° F. (1,010° C.). In another example, the first holding temperature 436 may be less than 2,400° F. (1,316° C.). In yet other examples, the first holding temperature 436 may be any value in a range between 1,850° F. (1,010° C.) and 2,400° F. (1,316° C.). In some embodiments, it may be critical that the first holding temperature 436 is approximately equal to the solutionizing temperature of the integral metallic connection to solutionize the metallic alloy of the integral metallic connection.

In accordance with at least one embodiment of the present disclosure, holding the integral metallic connection at the first holding temperature 436 for the first holding period 437 removes an existing heat treatment or hardening treatment of the integral metallic connection. As will be understood, removing the existing heat treatment may soften and/or reduce the hardness of the integral metallic connection.

After the first holding period 437, the bit and integral metallic connection may be cooled to room temperature 438 (e.g., less than approximately 100° F. (38° C.)). When the bit and integral metallic connection are cooled to room temperature 438, the bit may be de-molded. The duration spent at room temperature 438 may be variable, and based on the workflow at the manufacturing facility, including how long it takes to de-mold and process the bit.

The bit and the integral metallic connection may be heated to a second holding temperature 440. The bit and the integral metallic connection may be held at the second holding temperature 440 for a second holding period 439. The second holding temperature 440 may be a braze pre-heat temperature. Heating the bit to the braze pre-heat temperature may help to reduce the thermal difference between portions of the bit during brazing, which may help to reduce the chance of the matrix body cracking. After pre-heating the bit and the integral metallic connection to the second holding temperature 440, the cutting elements may be brazed to the bit.

In some embodiments, the second holding temperature 440 may be associated with a precipitate hardening temperature of the integral metallic connection. For example, the braze pre-heat temperature may be the same as, or approximately the same as the precipitate hardening temperature. Holding the integral metallic connection at the precipitate hardening temperature may cause the microstructure of the integral metallic connection to change, causing one or more crystals in the microstructure of the integral metallic connection to precipitate in the solid solution. This may result in a precipitate hardened microstructure of the integral metallic connection. As discussed herein, the precipitate hardened microstructure may be formed by the thermal cycle that results in the hardened strength of the integral metallic connection. This may increase the strength and/or hardness of the integral metallic connection.

In some embodiments, the second holding temperature 440 may be in a range having an upper value, a lower value, or upper and lower values including any of 900° F. (482° C.), 1,000° F. (538° C.), 1,100° F. (593° C.), 1,200° F. (649° C.), or any value therebetween. For example, the second holding temperature 440 may be greater than 900° F. (482° C.). In another example, the second holding temperature 440 may be less than 1,200° F. (649° C.). In yet other examples, the second holding temperature 440 may be any value in a range between 900° F. (482° C.) and 1,200° F. (649° C.). In some embodiments, it may be critical that the second holding temperature 440 is approximately equal to the precipitate hardening temperature of the integral metallic connection to result in a hardened strength of the integral metallic connection. In some embodiments, the precipitate hardening temperature is a temperature range, such as within 10 to 50° F. of a phase change temperature of the integral metallic connection material.

The first thermal cycle 430-1 may result in a treated strength of the integral metallic connection. In some embodiments, the treated strength may be in a range having an upper value, a lower value, or upper and lower values including any of 90 ksi (621 MPa), 100 ksi (689 MPa), 110 ksi (748 MPa), 120 ksi (827 MPa), 130 ksi (896 MPa), 140 ksi (965 MPa), 150 ksi (1,034 MPa), or any value therebetween. For example, the treated strength may be greater than 90 ksi (621 MPa). In another example, the treated strength may be less than 150 ksi (1,034 MPa). In yet other examples, the treated strength may be any value in a range between 90 ksi (621 MPa) and 150 ksi (1,034 MPa). In some embodiments, it may be critical that the treated strength is greater than 100 ksi (689 MPa) to meet or exceed API standards. Moreover, it is appreciated that the API standards for sufficient connection strength may be based at least in part on the diameter of the bit or other connection component.

In some embodiments, the first thermal cycle 430-1 is based on the manufacturing cycle of the bit. For example, the first holding temperature 436 may be based on the infiltration temperature to manufacture the bit (which may meet or exceed the solutionizing temperature of the integral metallic connection) and the second holding temperature 440 may be based on the braze pre-heat temperature used before brazing the bit. The second holding temperature 440 may also be selected based on the precipitate hardening temperature of the integral metallic connection. In this manner, precipitate hardening of the integral metallic connection may occur without interrupting, slowing down, or otherwise impacting the manufacturing process of the bit. This may help to reduce manufacturing time and/or costs of the bit.

In some embodiments, the material used for the integral metallic connection may be matched to the manufacturing process of the bit. For example, the material used for the integral metallic connection may be selected as having a solutionizing temperature that is the same as, or approximately the same as, or less than, the melting point of the particular infiltrant used for the matrix body. Further, the material used for the integral metallic connection may have a precipitate hardening temperature that is the same as, or approximately the same as, or in a temperature range that overlaps, the brazing pre-heat temperature of the bit. In this manner, as discussed herein, precipitate hardening of the integral metallic connection may occur without interrupting, slowing down, or otherwise impacting the manufacturing process of the bit. This may help to reduce manufacturing time and/or costs of the bit.

In some embodiments, the infiltrant and brazing material used may be based on the material used for the integral metallic connection. For example, the infiltrant used may be selected to have a melting temperature that is the same as or greater than the solutionizing temperature for the integral metallic connection. The brazing material used may be selected to have a braze pre-heat temperature that is the same as or within a precipitate hardening range of the integral metallic connection material.

In some embodiments, the first holding period 437 may be based on the infiltration period for the infiltrant to fully infiltrate the matrix material powder to form the infiltrated matrix body. In some embodiments, the integral metallic connection may fully solutionize during the infiltration period. In some embodiments, the first holding period 437 may be extended to allow for solutionizing of the integral metallic connection.

In some embodiments, the second holding period 439 may be based on the amount of time it may take to fully pre-heat the entire bit, including the integral metallic connection. The integral metallic connection may precipitate harden during the pre-heat period. In some embodiments, the second holding period 439 may be extended to allow the integral metallic connection to achieve the desired strength during precipitate hardening.

In some embodiments, the first thermal cycle 430-1 has a cool-down period 442. To cool the bit and the integral metallic connection, the bit and the integral metallic connection may be slow-cooled and/or air-cooled. In some embodiments, the bit and the integral metallic connection may not be water and/or oil quenched. In some embodiments, the material of the integral metallic connection may be selected to result in the hardened strength through a slow-cooling or air-cooling process. As discussed herein, the connection portion of the integral metallic connection of the bit may be processed and/or machined into a connection after the cool-down period 442.

FIG. 4-2 is a representation of a second thermal cycle chart 428-2 having a second thermal cycle 430-2. The second thermal cycle 430-2 may include heating the bit and integral metallic connection to the first holding temperature 436 for the first holding period 437. The second thermal cycle 430-2 may then include cooling the bit and integral metallic connection to the room temperature 438. The bit and integral metallic connection may be heated to the second holding temperature 440 and held for the second holding period 439.

In the embodiment shown, the second thermal cycle 430-2 includes a first cool-down period 442-1 and a second cool-down period 442-2. In some embodiments, the first cool-down period 442-1 and the second cool-down period 442-2 may have different cooling rates. For example, the first cool-down period 442-1 may have a slower cooling rate than the second cool-down period 442-2. In some examples, the first cool-down period 442-1 may be a slow-cooling period. The second cool-down period 442-2 may be an air-cooling period. Cooling the integral metallic connection with different cooling rates may adjust the formation of microstructures within the integral metallic connection. In this manner, by controlling the cooling of the integral metallic connection, the microstructure of the integral metallic connection may be controlled, thereby controlling the resulting hardened strength of the integral metallic connection.

FIG. 4-3 is a representation of a third thermal cycle chart 428-3 having a third thermal cycle 430-3. The third thermal cycle 430-3 may include heating the bit and integral metallic connection to the first holding temperature 436 for the first holding period 437. The third thermal cycle 430-3 may then include cooling the bit and integral metallic connection to the room temperature 438.

In some embodiments, the bit and integral metallic connection may be heated to a second holding temperature 440-1 and hold the integral metallic connection at the second holding temperature 440-1 for the second holding period 439. In some embodiments, the third thermal cycle 430-3 may include adjusting the temperature of the bit and integral metallic connection to a lower third holding temperature 440-2 and holding at the lower third holding temperature 440-2 for a third holding period 441. Heating and/or adjusting the temperature of the integral metallic connection to the second holding temperature 440-1 and the third holding temperature 440-2 may help to control the resulting hardened strength of the integral metallic connection. For example, the second holding temperature 440-1 may be the braze pre-heat temperature and the third holding temperature 440-2 may be the precipitate hardening temperature. After the cutting elements are brazed to the matrix body, the temperature of the bit and the integral metallic connection may be reduced to the third holding temperature and held for a third holding period 441. This may reduce the energy consumption for both brazing the cutting elements on the bit and precipitation hardening the integral metallic connection when the precipitate hardening temperature is less than the braze pre-heat temperature.

In some embodiments, the second holding temperature 440-1 is the precipitate hardening temperature, and the second holding period 439 is selected to achieve a desired precipitate microstructure within the integral metallic connection. After the second holding period 439, the bit and the integral metallic connection may cool to the third holding temperature 440-2. The third holding temperature 440-2 may be the braze pre-heat temperature, which is sufficient to reduce thermal shock to the bit and the integral metallic connection during the brazing process. The cutting elements may be brazed to the bit during the third holding period 441. In some embodiments, tempering and/or further precipitate hardening may be avoided at least in part because the third holding temperature 440-2 is less than the second holding temperature 440-1. This may help to reduce the amount of time that the integral metallic connection spends above the precipitate hardening temperature (second holding temperature 440-1), which may improve the hardening of the precipitate hardening process.

FIG. 4-4 is a representation of a fourth thermal cycle chart 428-4 having a fourth thermal cycle 430-4. The fourth thermal cycle 430-4 may include heating the bit and integral metallic connection to the first holding temperature 436 for the first holding period 437. The fourth thermal cycle 430-4 may then include cooling the bit and integral metallic connection to the room temperature 438.

In some embodiments, the bit and integral metallic connection may be heated to a second holding temperature 440-1 and held for the second holding period 439. In some embodiments, the bit and integral metallic connection may be cooled and then heated to a third holding temperature 440-2 and held for the third holding period 441. In some embodiments, the second holding temperature 440-1 and the lower third holding temperature 440-2 may be different. For example, the second holding temperature 440-1 may include a transformation temperature for the integral metallic connection. After soaking the integral metallic connection at the second holding temperature 440-1, the infiltrated bit and the integral metallic connection may be cooled back to room temperature 438 prior to re-heating to the third holding temperature 440-2, which may be the braze pre-heat temperature. In some embodiments, the second holding temperature 440-1 and the third holding temperature 440-2 may be the same. While the embodiment shown includes two holding temperatures 440, it should be understood that the fourth thermal cycle 430-4 may include multiple holding temperatures 440, with separate holding temperatures 440 having the same and/or different temperatures. Moreover, the holding periods for the separate holding temperatures 440 may vary.

In some embodiments, using multiple holding temperatures 440 may help with the heat treatment of the integral metallic connection. For example, multiple holding temperatures 440 may allow for an annealing process, which may help to improve the heat treatment of the integral metallic connection.

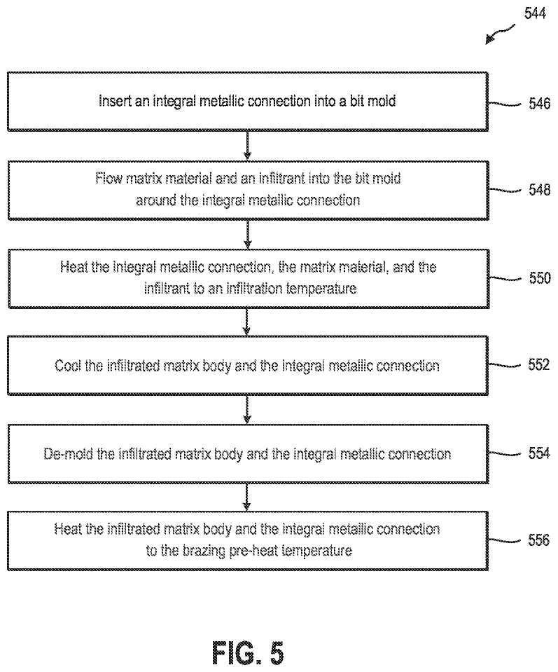

FIG. 4-5 is an illustration of a fourth thermal cycle chart 428-4 that can have a fourth thermal cycle 430-4. The fourth thermal cycle 430-4 may include heating the bit and integral metallic connection to a first holding temperature 436 and holding for a first holding period 437. The fourth thermal cycle 430-4 may include a stress relief temperature 442 and held for a stress relief time 444. In various embodiments, the stress relief of the fourth thermal cycle 430-4 may be followed by a cooling bit and integral metallic connection to a room temperature 438. The heating followed by a stress relief prior to increased cooling rate can improve the stress properties of the metallic connection.

In some embodiments, the second holding temperature 440-1 is the precipitate hardening temperature, and the second holding period 439 is selected to achieve a desired precipitate microstructure within the integral metallic connection. After the second holding period 439, the bit and the integral metallic connection may cool via a cool down period 446. To cool the bit and the integral metallic connection, the bit and the integral metallic connection may be slow-cooled and/or air-cooled. In some embodiments, the bit and the integral metallic connection may be water and/or oil quenched. In other embodiments, the bit and the integral metallic connection may not be water and/or oil quenched and/or cooled. In some embodiments, the material of the integral metallic connection may be selected to result in the hardened strength through a slow-cooling or air-cooling process. As discussed herein, the connection portion of the integral metallic connection of the bit may be processed and/or machined into a connection after the cool-down period 442

FIG. 5 is a flowchart of a method 544 for manufacturing a bit, according to at least one embodiment of the present disclosure. The method 544 may including inserting an integral metallic connection into a bit mold at 546. As discussed herein, the integral metallic connection may include a matrix portion and a connection portion. The matrix portion of the integral metallic connection may be inserted into an inverted representation of the matrix portion of the bit. A matrix material may be flowed into the bit mold around the matrix portion of the integral metallic connection at 548. An infiltrant may be flowed into the bit mold around the integral metallic connection.

As discussed herein, the bit mold, the matrix material, and the infiltrant may be heated to an infiltration temperature at 550. At the infiltration temperature, the infiltrant may melt and flow into the spaces between the grains of the matrix material. In some embodiments, at least a portion of the infiltrant may come into contact with the matrix portion of the integral metallic connection and bond to the matrix portion of the integral metallic connection. This may form an infiltrated matrix body with the matrix portion of the integral metallic connection embedded in the infiltrated matrix body. As discussed herein, the infiltration temperature may meet or exceed the solutionizing temperature of the integral metallic connection. This may cause the integral metallic connection to solutionize, which may remove any existing heat-treatment of the integral metallic connection.

The infiltrated matrix body and the integral metallic bit may be cooled at 552. The cooled infiltrated matrix body and integral metallic bit may be de-molded at 554. In some embodiments, prior to brazing cutting elements on the infiltrated matrix body, the infiltrated matrix body and the integral metallic connection may be heated to a brazing pre-heat temperature at 556. As discussed herein, the brazing pre-heat temperature may be associated with the precipitate hardening temperature of the integral metallic connection. This may cause the integral metallic connection to undergo precipitate hardening, thereby increasing the strength of the integral metallic connection to a hardened strength.

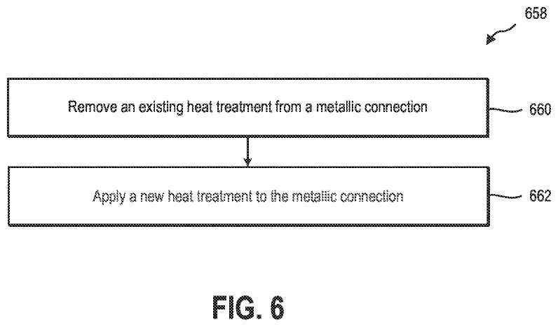

FIG. 6 is a flowchart of a method 658 for manufacturing a bit, according to at least one embodiment of the present disclosure. During manufacturing of the bit, the existing heat treatment of an integral metallic connection (e.g., integral metallic blank) may be removed at 660. As discussed herein, the integral metallic connection may include an embedded portion that is embedded in the matrix body of the bit. The integral metallic connection may include a connection portion, integrally formed with the embedded portion, that extends out of the matrix body of the bit. The integral metallic connection may have an existing heat treatment that was applied during manufacturing of the integral metallic connection. A matrix portion of the integral metallic connection having the existing heat treatment may be inserted into an inverted representation of a bit in a bit mold with matrix material flowed around it, with a connection portion extending out of the matrix body. The existing heat treatment may be removed when the matrix material and the infiltrant are heated to infiltrate the matrix material.

In some embodiments, a new heat treatment may be applied to the integral metallic connection at 662. The new heat treatment may include a thermal cycle that results in a hardened strength of 110 ksi or greater. In some embodiments, the new heat treatment may be applied when the infiltrated matrix body and the integral metallic connection are pre-heated prior to brazing. In some embodiments, the new heat treatment may be applied using brazing pre-heat temperature for the matrix body. In some embodiments, the new heat treatment may be applied using a precipitate hardening temperature that is determined based on the particular metallic alloy of the integral metallic connection.

An experiment was performed in accordance with at least one embodiment of the present disclosure. An integral metallic connection was formed from 17-4PH steel alloy. The integral metallic connection was heated to an infiltration temperature of approximately 2,100° F. The integral metallic connection was cooled to room temperature. The integral metallic connection was then heated to a brazing pre-heat temperature of 1,050° F. Hardness and strength results after cooling from the brazing pre-heat temperature are shown below in Table 1.

TABLE 1

| | Size | Yield Strength | Tensile Strength | Hardness |
|---|---|---|---|---|
| No. | (in.) | (psi) | (psi) | (HRC) |
| 1 | 0.252 | 183,900 | 210,000 | 44 |
| 2 | 0.250 | 186,800 | 210,000 | 44 |

As may be seen, the hardened tensile strength of both samples is 210,000 psi, and the hardness of both samples was 44 HRC. This indicates that thermal cycles in accordance with at least one embodiment of the present disclosure may result in hardened strength that meets or exceeds API tensile AND connection strength standards.

The embodiments of the bit having an integral metallic connection have been primarily described with reference to wellbore drilling operations; the bit having an integral metallic connection described herein may be used in applications other than the drilling of a wellbore. In other embodiments, bits having an integral metallic connection according to the present disclosure may be used outside a wellbore or other downhole environment used for the exploration or production of natural resources. For instance, bits having an integral metallic connection of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Moreover, it should be understood that references to “at least one of A and B” should be understood to mean “only A, only B, or both A and B.” That is, the disjunctive meaning is intended.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A bit, comprising:
a matrix body including a matrix material, the matrix material including a matrix material powder bound by an infiltrant; and
an integral metallic connection including a matrix portion embedded in the matrix body and a connection portion extended from the matrix body, the connection portion and the matrix portion integrally formed with each other, wherein the integral metallic connection has a treated strength that is greater than or equal to 90 ksi.

2. The bit in claim 1, wherein the integral metallic connection has a precipitate hardened microstructure.

3. The bit of claim 2, comprising a plurality of cutting elements brazed to cutter pockets of the matrix body via a brazing process, wherein the precipitate hardened microstructure is formed by a thermal cycle associated with the brazing process.

4. The bit of claim 1, wherein the matrix body includes a bit breaker in a gage region.

5. The bit of claim 1, wherein the integral metallic connection is formed from at least one of a ferrous-based alloy, a cobalt-based alloy, or a nickel-based alloy.

6. The bit of claim 1, wherein the bit comprises a diameter, and the treated strength of the integral metallic connection is equal to or greater than an API standard for the diameter of the bit.

7. A method for manufacturing a bit, comprising:
providing the bit comprising a matrix body and a metallic connection, wherein the metallic connection is at least partially embedded in the matrix body, and a yield strength of the metallic connection is less than 90 ksi; and
applying a new heat treatment to the matrix body and the metallic connection to increase the yield strength of the metallic connection to greater than 90 ksi.

8. The method of claim 7, comprising infiltrating a matrix powder with an infiltrant to form the matrix body prior to applying the new heat treatment, wherein infiltrating the matrix powder comprises:
heating the matrix body and the metallic connection to an infiltration temperature; and
removing an existing heat treatment of the metallic connection.

9. The method of claim 7, further comprising, after applying the new heat treatment, preparing a threaded connection at a connection portion of the metallic connection.

10. The method of claim 7, wherein the thermal cycle includes air-cooling to a room temperature.

11. A method for manufacturing a bit, comprising:
inserting an integral metallic connection into a bit mold, the integral metallic connection including a matrix portion integrally formed with a connection portion;
flowing matrix material and an infiltrant into the bit mold around the integral metallic connection, the matrix material including a matrix material powder;
heating the integral metallic connection, the matrix material, and the infiltrant to an infiltration temperature to form an infiltrated matrix body with the integral metallic connection embedded in the infiltrated matrix body;
cooling the infiltrated matrix body and the integral metallic connection to a room temperature;
de-molding the infiltrated matrix body and the integral metallic connection from the bit mold; and
heating the infiltrated matrix body and the integral metallic connection to a brazing pre-heat temperature.

12. The method of claim 11, wherein the infiltration temperature meets or exceeds a minimum solutionizing temperature of the integral metallic connection.

13. The method of claim 12, wherein the infiltration temperature is between 1,900° F. (1,010° C.) and 2,400° F. (1,316° C.).

14. The method of claim 11, further comprising air-cooling the integral metallic connection after heating the integral metallic connection to the brazing pre-heat temperature.

15. The method of claim 11, further comprising directionally quenching the integral metallic connection after heating the integral metallic connection to the infiltration temperature.

16. The method of claim 11, wherein the brazing pre-heat temperature is associated with a microstructural refinement of the integral metallic connection to improve mechanical properties.

17. The method of claim 16, wherein the brazing pre-heat temperature is between 900° F. (482° C.) and 1,200° F. (649° C.).

18. The method of claim 16, further comprising brazing a plurality of cutting elements to the bit, without thermally protecting the integral metallic connection from brazing heat.

19. The method of claim 11, comprising:
heating the infiltrated matrix body and the integral metallic connection to a precipitate hardening temperature between the infiltration temperature and the pre-heat temperature; and
cooling the infiltrated matrix body and the integral metallic connection to the pre-heat temperature or to the room temperature.

20. The method of claim 11, wherein cooling the bit to the room temperature includes air cooling the bit to the room temperature.
